(19) United States
(12) Patent Application Publication
(10) Pub. No.: US 2014/0217994 A1
(43) Pub. Date: Aug. 7, 2014

(54) ELECTRONIC DEVICE WITH FAST CHARGING CIRCUIT

(71) Applicant: HON HAI PRECISION INDUSTRY CO., LTD., New Taipei (TW)

(72) Inventors: CHUN-WEI KUO, New Taipei (TW); CHIN-LUNG HO, New Taipei (TW)

(73) Assignee: HON HAI PRECISION INDUSTRY CO., LTD., New Taipei (TW)

(21) Appl. No.: 13/866,043

(22) Filed: Apr. 19, 2013

(30) Foreign Application Priority Data
Feb. 4, 2013 (TW) 102104134

(51) Int. Cl. H02J 7/00

(52) U.S. Cl. CPC H02J 7/0052
USPC 320/160

(57) ABSTRACT

An electronic device includes a pre-charging circuit and a battery. The pre-charging circuit is electrically connected to an external power supply and continually charges the battery of the electronic device. The electronic device further includes a fast charging circuit which includes a switch, a comparator and a NOR gate. The switch is electrically connected between the external power supply and the battery and the comparator is electrically connected to the battery. The NOR gate is electrically connected to the pre-charging circuit, the comparator, and the switch, and outputs signals to control the switch according to the comparison against a reference voltage and the signal outputted by the pre-charging circuit. The electronic device uses the pre-charging circuit and the fast charging circuit to quickly charge the battery of the electronic device when the battery is low, which shortens the charging time.

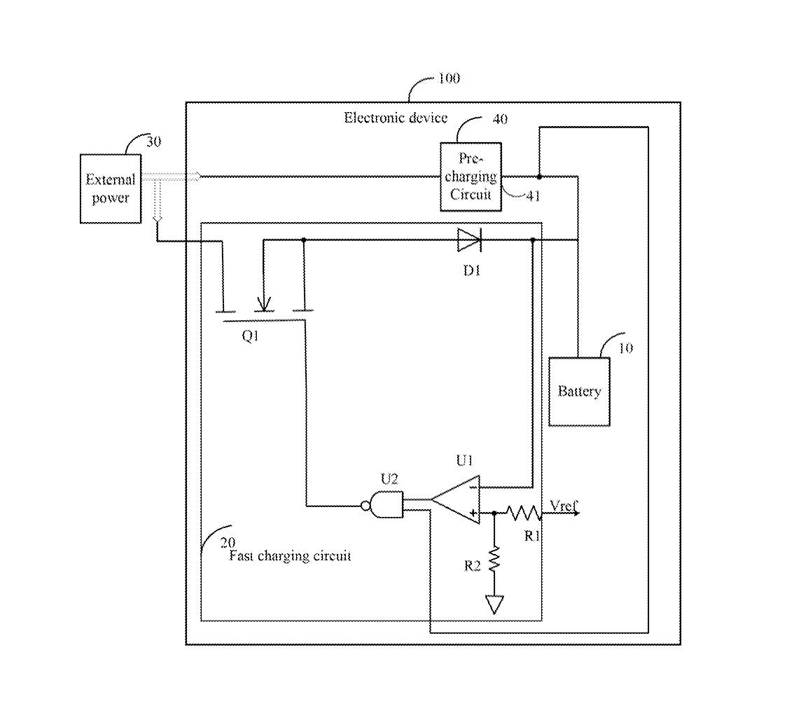

### TECHNICAL FIELD

The disclosure relates to electronic devices, and particularly to an electronic device with a charging circuit.

### DESCRIPTION OF RELATED ART

As handheld devices, such as mobile phones and E-books, become more powerful, the handheld devices require more powerful batteries for longer use times. Thus, it becomes necessary to fast charge such batteries.

### BRIEF DESCRIPTION OF THE DRAWINGS

The FIGURE is a diagram showing an application environment and detailed circuit plan of one embodiment of an electronic device.

### DETAILED DESCRIPTION

The FIGURE is a diagram showing an application environment and detailed circuit of one embodiment of an electronic device 100.

In one embodiment, the electronic device 100 includes a pre-charging circuit 40 and a fast charging circuit 20. The fast charging circuit 20 and the pre-charging circuit 40 are both electrically connected between an external power supply 30 and a battery 10 of the electronic device 100. The fast charging circuit 20 and the pre-charging circuit 40 both charge the battery 10 of the electronic device 100 when the fast charging circuit 20 starts working. Only the pre-charging circuit charges the battery 10 of the electronic device 100 when the fast charging circuit 20 is not working. In one embodiment, the electronic device 100 may be a smart phone, a tablet computer, an electronic book, or any other portable electronic product.

The pre-charging circuit 40 is electrically connected to an external power 30. The pre-charging circuit 40 charges the battery 10 of the electronic device 100. In one embodiment, the pre-charging circuit 40 includes a low current charging circuit, which is electrically connected between the external power 30 and the battery 10. The low current charging circuit includes a detect pin 41. When the detect pin 41 detects that a voltage of the battery 10 is at least equal to a saturation voltage of the battery 10, the detect pin 41 outputs a first high level signal (logic 1) to the fast charging circuit 20. When the detect pin 41 detects that the voltage of the battery 10 is less than the saturation voltage of the battery 10, the detect pin 41 outputs a first low level signal (logic 0) to the fast charging circuit 20.

In one embodiment, the fast charging circuit 20 includes a switch Q1, a comparator U1 and a NOR gate U2. The switch Q1 is electrically connected between the external power 30 and the battery 10 and controls the fast charging circuit 20. In one embodiment, the switch Q1 may be an N-type metallic field effect transistor. The terminal of the switch Q1 which is electrically connected to the external power 30, which is a drain electrode of the N-type metallic field effect transistor, the terminal of the switch Q1 which is electrically connected to the battery 10 is a source electrode of the N-type metallic field effect transistor, and the third terminal of the switch Q1, is electrically connected to NOR gate U2, which is the gate electrode of the N-type metallic field effect transistor.

The comparator U1 is electrically connected to the battery 10 and compares the voltage of the battery 10 against a reference voltage Vref. The comparator U1 includes a positive input terminal, a negative input terminal, and an output terminal. The negative input terminal is electrically connected to the battery 10, the positive input terminal is the reference voltage terminal, and the output terminal is electrically connected to the NOR gate U2. The comparator U1 compares the voltage of the battery 10 and the reference voltage Vref and outputs different level signals to the NOR gate according to the comparison.

The NOR gate U2 is electrically connected to the pre-charging circuit 40, the comparator U1 and the switch Q1. The NOR gate U2 turns the switch Q1 on and off according to the different signals outputted by the comparator U1 and the signals outputted by the pre-charging circuit 40. In one embodiment, the NOR gate U2 includes a first input terminal, a second input terminal and an output terminal. The first input terminal is electrically connected to the output terminal of the comparator U1, the second input terminal is electrically connected to the pre-charging circuit 40, and the output terminal is electrically connected to the gate electrode of the switch Q1.

In other embodiments, the fast charging circuit 20 further includes a first resistor R1 and a second resistor R2. One terminal of the first resistor R1 is electrically connected to the positive input terminal of the comparator U1, and another terminal of the first resistor R1 is grounded.

In another embodiment, the fast charging circuit 20 includes a diode D1 to prevent current backflow from the battery 10. An anode of the diode D1 is electrically connected to the source electrode of the switch Q1, and a cathode of the diode D1 is electrically connected to the battery 10.

The switch Q1 controls operations of the fast charging circuit 20. The switch being either ON or OFF is controlled by the signal outputted by the NOR gate U2. The signal outputted by the NOR gate U2 is itself governed by the pre-charging circuit and the signal outputted by the comparator U1.

The comparator U1 outputs a second high level signal when the battery 10 voltage is less than the reference voltage Vref, and outputs a second low level signal when the battery 10 voltage is at least equal to the reference Vref. When both the comparator U1 and the pre-charging circuit 40 output a low level signal, the NOR gate U2 outputs a third high level signal to switch on the switch Q1. When the pre-charging circuit 40 and the comparator U1 output different levels of signal, the NOR gate U2 outputs a third low level signal to switch the switch Q1 OFF.

In one embodiment, when the switch is ON, the fast charging circuit starts working, and both the fast charging circuit 20 and the pre-charging circuit 40 charge the battery 10 of the electronic device 100. When the switch Q1 is OFF, the fast charging circuit 40 is not working and only the pre-charging circuit 40 charges the battery 10 of the electronic device 100.

As previously mentioned, when the battery 10 has low power, such as less than approximately 10% of current of the fast charging circuit 20, the voltage of the battery 10 is less than the reference voltage Vref. Then, the output terminal of the comparator U1 outputs the second high level signal to the first terminal of the NOR gate U2, and the pre-charging circuit 40 outputs the first low level signal to the second terminal of the NOR gate U2, which causes the NOR gate U2 to output the third low level signal to make the switch Q1 OFF. Then, the fast charging circuit 20 is not working and only the pre-charging circuit 40 charges the battery 10 of the electronic device 100.

When the battery 10 has been pre-charged for a period of time, the voltage of the battery 10 gradually increases to more than the reference voltage Vref. Then, the output terminal of the comparator U1 outputs the second low level signal to the first terminal of the NOR gate U2 and the pre-charging circuit 40 outputs the first low level signal to the second terminal of the NOR gate U2, which cause the NOR gate U2 to output the third high level signal to switch on the switch Q1. Then, the fast charging circuit 20 starts working and both the fast charging circuit 20 and the pre-charging circuit 40 are employed in charging the battery 10 of the electronic device 100.

When the voltage of the battery 10 is more than the saturation voltage of the battery 10, the voltage of the battery 10 will be more than the reference voltage Vref. Then, the output terminal of the comparator U1 outputs the second low level signal to the first terminal of the NOR gate, and the pre-charging circuit 40 outputs the first high level signal to the second terminal of the NOR gate, which causes the NOR gate to output the third low level signal to switch off the switch Q1. Then, the fast charging circuit 20 is not working and only the pre-charging circuit 40 charges the battery 10 of the electronic device 100.

In the embodiments of the present invention, when the fast charging circuit 20 starts working, the fast charging circuit 20 accelerates the charging of the battery 10 and decreases the charging time. When the fast charging circuit 20 stops working, only the pre-charging circuit 40 charges the battery 10, which lengthens service life of the battery 10.

What is claimed is:

1. An electronic device, comprising:
a pre-charging circuit electrically connected to an external power, the pre-charging circuit charging a battery of the electronic device;
a fast charging circuit, comprising:
a switch electrically connected between the external power and the battery;
a comparator electrically connected with the battery, the comparator comparing a voltage of the battery and a reference voltage; and
a NOR gate electrically connected with the pre-charging circuit, the comparator, and the switch; the NOR gate outputting control signals to control the switch on or off according the comparison of the comparator and a level signal outputted by the pre-charging circuit.

2. The electronic device of claim 1, wherein the pre-charging circuit outputs a first low level signal to the NOR gate when the voltage of the battery is less than a saturation voltage of the battery and outputs a first high level signal to the NOR gate when the voltage of the battery is not less than the saturation voltage of the battery.

3. The electronic device of claim 2, wherein the comparator outputs a second high level signal to the NOR gate when the voltage of the battery is less than the reference voltage and outputs a second low level signal to the NOR gate when the voltage of the battery is not less than the reference voltage.

4. The electronic device of claim 3, wherein the NOR gate outputs a third high level signal to turn on the switch when the comparator and the pre-charging circuit output the first and second low level signals to the NOR gate, and outputs a third low level signal to turn off the switch when the pre-charging circuit and the comparator output different level signals to the NOR gate.

5. The electronic device of claim 1, wherein the switch is an N-type metallic field effect transistor, one terminal of the switch connected to the external power is a drain electrode of the N-type metallic field effect transistor, another terminal of the switch connected to the battery is a source electrode of the N-type metallic field effect transistor, and a third terminal of the switch connected to the NOR gate is a gate electrode of the N-type metallic field effect transistor.

6. The electronic device of claim 1, wherein the pre-charging circuit comprises a low current charging circuit electrically connected between the external power and the battery, wherein the low current charging circuit comprises a detect pin that outputs a high level signal to the NOR gate when the detect pin detects that the voltage of the battery is not less than the saturation voltage.

7. The electronic device of claim 1, wherein the pre-charging circuit further comprises a diode, an anode of the diode is electrically connected to the switch, and a cathode of the diode connected to the battery, to prevent current of the battery from backflow.
